(19) United States
(12) Patent Application Publication
(10) Pub. No.: US 2023/0312916 A1
(43) Pub. Date: Oct. 5, 2023

(54) BLOW-MOLDED OR INJECTION-MOLDED ARTICLE

(71) Applicant: KANEKA CORPORATION, Osaka-shi (JP)

(72) Inventor: Tomoaki HASHIGUCHI, Settsu-shi (JP)

(73) Assignee: KANEKA CORPORATION, Osaka-shi (JP)

(21) Appl. No.: 18/043,934

(22) PCT Filed: Sep. 6, 2021
(86) PCT No.: PCT/JP2021/032667

§ 371 Date: Mar. 3, 2023

(30) Foreign Application Priority Data
Sep. 11, 2020 (JP) 2020-152731

(51) Int. Cl. C08L 67/04

(52) U.S. Cl. CPC C08L 67/04; C08L 2205/025; C08L 2205/03

(57) ABSTRACT

A molded article contains a poly(3-hydroxyalkanoate) resin component. The poly(3-hydroxyalkanoate) resin component includes: a copolymer (A) which is a copolymer of 3-hydroxybutyrate units and other hydroxyalkanoate units and in which the content of the other hydroxyalkanoate units is from 1 to 6 mol %; and a copolymer (B) which is a copolymer of 3-hydroxybutyrate units and other hydroxyalkanoate units and in which the content of the other hydroxyalkanoate units is 24 mol % or more. In the poly(3-hydroxyalkanoate) resin component, the proportion of the copolymer (A) is from 40 to 90 wt %, and the proportion of the copolymer (B) is from 10 to 60 wt %. A 50% fracture energy of the molded article, as measured by a DuPont impact test, is 0.3 J or more.

### TECHNICAL FIELD

The present invention relates to a blow-molded or injection-molded article containing a poly(3-hydroxyalkanoate) resin component.

### BACKGROUND ART

In recent years, separate collection and composting of raw garbage have been promoted especially in Europe, and plastic products that can be composted together with raw garbage have been desired. Additionally, marine pollution caused by microplastics has become an issue of great concern, and there is a demand for development of plastics degradable in seawater.

Poly(3-hydroxyalkanoate) resins are thermoplastic polyesters produced and accumulated as energy storage substances in cells of many kinds of microorganisms. These resins are biodegradable in seawater as well as in soil and thus are attracting attention as materials that can be a solution to the above-mentioned problems.

Patent Literature 1 discloses a bottle made of a poly(3-hydroxybutyrate) resin and having a wall thickness of 0.1 to 5.0 mm.

### CITATION LIST

### Patent Literature

PTL 1: WO 2020/095799

### SUMMARY OF INVENTION

### Technical Problem

Molding is difficult in the case of producing blow-molded or injection-molded articles using previously-reported poly(3-hydroxyalkanoate) resins. Even if a molded article is obtained by molding, the molded article has insufficient impact resistance. There is a demand for improvement in these respects.

In view of the above circumstances, the present invention aims to provide a blow-molded or injection-molded article containing a poly(3-hydroxyalkanoate) resin component, producible with high moldability, and having high impact resistance.

### Solution to Problem

As a result of intensive studies with the goal of solving the above problem, the present inventors have found that a blow-molded or injection-molded article containing a poly(3-hydroxyalkanoate) resin component is producible with high moldability and has high impact resistance when two poly(3-hydroxyalkanoate) resins differing in the contents of constituent monomers are used in given proportions. Based on this finding, the inventors have completed the present invention.

Specifically, the present invention relates to a blow-molded or injection-molded article containing a poly(3-hydroxyalkanoate) resin component, wherein

the poly(3-hydroxyalkanoate) resin component includes: a copolymer (A) which is a copolymer of 3-hydroxybutyrate units and other hydroxyalkanoate units and in which a content of the other hydroxyalkanoate units is from 1 to 6 mol %; and a copolymer (B) which is a copolymer of 3-hydroxybutyrate units and other hydroxyalkanoate units and in which a content of the other hydroxyalkanoate units is 24 mol % or more,

in the poly(3-hydroxyalkanoate) resin component, a proportion of the copolymer (A) is from 40 to 90 wt % and a proportion of the copolymer (B) is from 10 to 60 wt %, and

a 50% fracture energy of the molded article, as measured by a DuPont impact test, is 0.3 J or more.

Preferably, an average content of the other hydroxyalkanoate units in total monomer units constituting the poly(3-hydroxyalkanoate) resin component is from 7 to 19 mol %.

Preferably, the other hydroxyalkanoate units are 3-hydroxyhexanoate units.

The blow-molded or injection-molded article may further contain a nucleating agent and/or a lubricant.

The blow-molded or injection-molded article may further contain 1 to 30 parts by weight of an inorganic filler per 100 parts by weight of the poly(3-hydroxyalkanoate) resin component.

### Advantageous Effects of Invention

The present invention can provide a blow-molded or injection-molded article containing a poly(3-hydroxyalkanoate) resin component, producible with high moldability, and having high impact resistance.

### DESCRIPTION OF EMBODIMENTS

Hereinafter, embodiments of the present invention will be described. The present invention is not limited to the embodiments described below.

One embodiment of the present invention relates to a blow-molded or injection-molded article containing a poly(3-hydroxyalkanoate) resin component.

(Poly(3-hydroxyalkanoate) Resin Component)

The poly(3-hydroxyalkanoate) resin component used is a mixture of at least two poly(3-hydroxyalkanoate) resins differing in the contents of constituent monomers. The use of the mixture can provide a blow-molded or injection-molded article producible with high moldability and having high impact resistance.

Each of the poly(3-hydroxyalkanoate) resins is preferably a polymer containing 3-hydroxyalkanoate units, in particular a polymer containing units represented by the following formula (1).

[—CHR—CH₂—CO—O—] (1)

In the formula (1), R is an alkyl group represented by CₚH₂ₚ₊₁, and p is an integer from 1 to 15. Examples of the R group include linear or branched alkyl groups such as methyl, ethyl, propyl, methylpropyl, butyl, isobutyl, t-butyl, pentyl, and hexyl groups. The integer p is preferably from 1 to 10 and more preferably from 1 to 8.

Each of the poly(3-hydroxyalkanoate) resins is particularly preferably a microbially produced poly(3-hydroxyalkanoate) resin. In the microbially produced poly(3-hydroxyalkanoate) resin, all of the 3-hydroxyalkanoate units are contained as (R)-3-hydroxyalkanoate units.

Each of the poly(3-hydroxyalkanoate) resins preferably contains 50 mol % or more of 3-hydroxyalkanoate units (in particular, the units represented by the formula (1)) in the total structural units, and the content of the 3-hydroxyalkanoate units is more preferably 60 mol % or more and even more preferably 70 mol % or more. Each of the poly(3-hydroxyalkanoate) resins may contain only one type or two or more types of 3-hydroxyalkanoate units as polymer structural units or may contain other units (such as 4-hydroxyalkanoate units) in addition to the one type or two or more types of 3-hydroxyalkanoate units.

Each of the poly(3-hydroxyalkanoate) resins may be a homopolymer or copolymer containing 3-hydroxybutyrate (hereinafter also referred to as “3HB”) units. In particular, all of the 3-hydroxybutyrate units are preferably (R)-3-hydroxybutyrate units. Each of the poly(3-hydroxyalkanoate) resins is preferably a copolymer of 3-hydroxybutyrate units and other hydroxyalkanoate units.

Specific examples of the poly(3-hydroxyalkanoate) resins include

poly(3-hydroxybutyrate), poly(3-hydroxybutyrate-co-3-hydroxypropionate),
poly(3-hydroxybutyrate-co-3-hydroxyvalerate) abbreviated as “P3HB3HV”,
poly(3-hydroxybutyrate-co-3-hydroxyvalerate-3-hydroxyhexanoate),
poly(3-hydroxybutyrate-co-3-hydroxyhexanoate) abbreviated as “P3HB3HH”,
poly(3-hydroxybutyrate-co-3-hydroxyheptanoate),
poly(3-hydroxybutyrate-co-3-hydroxyoctanoate),
poly(3-hydroxybutyrate-co-3-hydroxynonanoate),
poly(3-hydroxybutyrate-co-3-hydroxydecanoate),
poly(3-hydroxybutyrate-co-3-hydroxyundecanoate), and
poly(3-hydroxybutyrate-co-4-hydroxybutyrate) abbreviated as “P3HB4HB”. In particular,
poly(3-hydroxybutyrate-co-3-hydroxyhexanoate) and
poly(3-hydroxybutyrate-co-4-hydroxybutyrate) are preferred in terms of factors such as the moldability and the mechanical properties of the blow-molded or injection-molded article, and
poly(3-hydroxybutyrate-co-3-hydroxyhexanoate) is more preferred.

The poly(3-hydroxyalkanoate) resin component contains at least one high-crystallinity poly(3-hydroxyalkanoate) resin and at least one low-crystallinity poly(3-hydroxyalkanoate) resin. In general, high-crystallinity poly(3-hydroxyalkanoate) resins are superior in terms of moldability but have low mechanical strength, while low-crystallinity poly(3-hydroxyalkanoate) resins have good mechanical properties although being inferior in terms of moldability. Mixing of a high-crystallinity poly(3-hydroxyalkanoate) resin and a low-crystallinity poly(3-hydroxyalkanoate) resin is expected to lead to the result that the high-crystallinity poly(3-hydroxyalkanoate) resin forms fine resin crystal grains and the low-crystallinity poly(3-hydroxyalkanoate) resin forms tie molecules that crosslink the resin crystal grains to one another. The combined use of these resins can provide a marked increase in the impact resistance of the blow-molded or injection-molded article while ensuring high moldability.

The high-crystallinity poly(3-hydroxyalkanoate) resin is a copolymer (A) of 3-hydroxybutyrate units and other hydroxyalkanoate units. The content of the 3-hydroxybutyrate units in the high-crystallinity poly(3-hydroxyalkanoate) resin is preferably higher than the average content of 3-hydroxybutyrate units in total monomer units constituting the poly(3-hydroxyalkanoate) resin component. Specifically, the content of the other hydroxyalkanoate units in the high-crystallinity resin (A) is preferably from 1 to 6 mol %, more preferably from 2 to 5 mol %, and even more preferably from 3 to 5 mol %.

The high-crystallinity poly(3-hydroxyalkanoate) resin (A) used can be any of the above-mentioned copolymers containing 3-hydroxybutyrate units. The resin (A) is preferably poly(3-hydroxybutyrate-co-3-hydroxyhexanoate) or

poly(3-hydroxybutyrate-co-4-hydroxybutyrate) and more preferably
poly(3-hydroxybutyrate-co-3-hydroxyhexanoate).

The low-crystallinity poly(3-hydroxyalkanoate) resin is a copolymer (B) of 3-hydroxybutyrate units and other hydroxyalkanoate units. The content of the 3-hydroxybutyrate units in the low-crystallinity poly(3-hydroxyalkanoate) resin is preferably lower than the average content of 3-hydroxybutyrate units in total monomer units constituting the poly(3-hydroxyalkanoate) resin component. Specifically, the content of the other hydroxyalkanoate units in the low-crystallinity resin (B) is preferably from 24 to 99 mol %, more preferably from 24 to 50 mol %, even more preferably from 24 to 35 mol %, and particularly preferably from 24 to 30 mol %.

The low-crystallinity poly(3-hydroxyalkanoate) resin (B) used can be any of the above-mentioned copolymers containing 3-hydroxybutyrate units. The resin (B) is preferably poly(3-hydroxybutyrate-co-3-hydroxyhexanoate) or

poly(3-hydroxybutyrate-co-4-hydroxybutyrate) and more preferably
poly(3-hydroxybutyrate-co-3-hydroxyhexanoate).

As to the proportion of each of the high-crystallinity poly(3-hydroxyalkanoate) resin (A) and the low-crystallinity poly(3-hydroxyalkanoate) resin (B) to the total amount of the resins (A) and (B), it is preferable, in terms of factors such as the impact resistance of the molded article, the moldability, and the handleability of the molded article, that the proportion of the resin (A) be from 40 to 90 wt % and the proportion of the resin (B) be from 10 to 60 wt %. More preferably, the proportion of the resin (A) is from 45 to 85 wt % and the proportion of the resin (B) is from 15 to 55 wt %. Even more preferably, the proportion of the resin (A) is from 50 to 80 wt % and the proportion of the resin (B) is from 20 to 50 wt %. Still even more preferably, the proportion of the resin (A) is from 55 to 75 wt % and the proportion of the resin (B) is from 25 to 45 wt %. Particularly preferably, the proportion of the resin (A) is from 60 to 70 wt % and the proportion of the resin (B) is from 30 to 40 wt %.

The poly(3-hydroxyalkanoate) resin component may contain only the high-crystallinity resin (A) and the low-crystallinity resin (B) or may further contain an additional poly(3-hydroxyalkanoate) resin. The additional poly(3-hydroxyalkanoate) resin may be a homopolymer of 3-hydroxybutyrate or may be a copolymer which is a copolymer of 3-hydroxybutyrate units and other hydroxyalkanoate units and in which the content of the other hydroxyalkanoate units is outside the ranges as defined for the resins (A) and (B).

The average content ratio between 3-hydroxybutyrate units and other hydroxyalkanoate units (3-hydroxybutyrate units/hydroxyalkanoate units) in total monomer units constituting the poly(3-hydroxyalkanoate) resin component is preferably from 93/7 to 81/19 (mol %/mol %), more preferably from 93/7 to 83/17 (mol %/mol %), even more preferably from 92/8 to 84/16 (mol %/mol %), and particularly preferably from 91/9 to 85/15 (mol %/mol %) in order to ensure both the impact resistance of the molded article and the moldability.

The average content ratio between different monomer units in total monomer units constituting the poly(3-hydroxyalkanoate) resin component can be determined by a method known to those skilled in the art, such as by a method described in paragraph [0047] of WO 2013/147139. The “average content ratio” refers to a molar ratio between different monomer units in total monomer units of the poly(3-hydroxyalkanoate) resin component and particularly refers to a molar ratio between different monomer units contained in the total mixture of the two or more poly(3-hydroxyalkanoate) resins constituting the poly(3-hydroxyalkanoate) resin component.

The weight-average molecular weight of the poly(3-hydroxyalkanoate) resin component is not limited to a particular range, but is preferably from 20×10⁴ to 200×10⁴, more preferably from 25×10⁴ to 150×10⁴, and even more preferably from 30×10⁴ to 100×10⁴ in order to ensure both the impact resistance of the molded article and the moldability.

The weight-average molecular weight of each of the poly(3-hydroxyalkanoate) resins constituting the poly(3-hydroxyalkanoate) resin component is not limited to a particular range. In order to ensure both the impact resistance of the molded article and the moldability, the weight-average molecular weight of the high-crystallinity poly(3-hydroxyalkanoate) resin is preferably from 20×10⁴ to 100×10⁴, more preferably from 22×10⁴ to 80×10⁴, and even more preferably from 25×10⁴ to 60×10⁴. In order to ensure both the impact resistance of the molded article and the moldability, the weight-average molecular weight of the low-crystallinity poly(3-hydroxyalkanoate) resin is preferably from 20×10⁴ to 250×10⁴, more preferably from 25×10⁴ to 230×10⁴, and even more preferably from 30×10⁴ to 200×10⁴.

The weight-average molecular weight of each poly(3-hydroxyalkanoate) resin or the poly(3-hydroxyalkanoate) resin component can be measured as a polystyrene-equivalent molecular weight by gel permeation chromatography (HPLC GPC system manufactured by Shimadzu Corporation) using a chloroform solution of the resin or resin component. The column used in the gel permeation chromatography may be any column suitable for weight-average molecular weight measurement.

The poly(3-hydroxyalkanoate) resin component is preferably one that has not been crosslinked by the use of a crosslinking agent such as an organic peroxide. That is, the poly(3-hydroxyalkanoate) resin component is preferably a resin component having no crosslinked structure.

The method for producing each of the poly(3-hydroxyalkanoate) resins is not limited to a particular technique, and may be a chemical synthesis production method or a microbial production method. A microbial production method is more preferred. The microbial production method used can be any known method. Known examples of bacteria that produce copolymers of 3-hydroxybutyrate with other hydroxyalkanoates include Aeromonas caviae which is a P3HB3HV- and P3HB3HH-producing bacterium and Alcaligenes eutrophus which is a P3HB4HB-producing bacterium. In particular, in order to increase the P3HB3HH productivity, Alcaligenes eutrophus AC32 (FERM BP-6038; see T. Fukui, Y Doi, J. Bacteriol., 179, pp. 4821-4830 (1997)) having a P3HA synthase gene introduced is more preferred. Such a microorganism is cultured under suitable conditions to allow the microorganism to accumulate P3HB3HH in its cells, and the microbial cells accumulating P3HB3HH are used. Instead of the above microorganism, a genetically modified microorganism having any suitable poly(3-hydroxyalkanoate) resin synthesis-related gene introduced may be used depending on the poly(3-hydroxyalkanoate) resin to be produced. The culture conditions including the type of the substrate may be optimized depending on the poly(3-hydroxyalkanoate) resin to be produced.

The method for obtaining a blend of two or more poly(3-hydroxyalkanoate) resins is not limited to a particular technique. The blend may be obtained by microbial production or chemical synthesis. Alternatively, the blend may be obtained by melting and kneading the two or more resins using a device such as an extruder, a kneader, a Banbury mixer, or a roll-mill or by dissolving and mixing the two or more resins in a solvent and drying the resulting mixture.

(Additional Resin)

The blow-molded or injection-molded article according to one embodiment may contain an additional resin in addition to the poly(3-hydroxyalkanoate) resins to the extent that the additional resin does not impair the effect of the present invention. Examples of the additional resin include: aliphatic polyester resins such as polybutylene succinate adipate, polybutylene succinate, polycaprolactone, and polylactic acid; and aliphatic-aromatic polyester resins such as polybutylene adipate terephthalate, polybutylene sebacate terephthalate, and polybutylene azelate terephthalate. The molded article may contain one additional resin or two or more additional resins.

The amount of the additional resin is not limited to a particular range, but is preferably 30 parts by weight or less, more preferably 20 parts by weight or less, and even more preferably 10 parts by weight or less per 100 parts by weight of the total amount of the poly(3-hydroxyalkanoate) resin component. The lower limit of the amount of the additional resin is not limited to a particular value and may be 0 part by weight.

(Inorganic Filler)

The blow-molded or injection-molded article according to one embodiment preferably contains an inorganic filler in order to increase the strength of the molded article.

The inorganic filler is not limited to a particular type, and may be any inorganic filler that can be added to the resin material for blow molding or injection molding. Examples of the inorganic filler include: silica-based inorganic fillers such as quartz, fumed silica, silicic anhydride, molten silica, crystalline silica, amorphous silica, a filler obtained by condensation of alkoxysilane, and ultrafine amorphous silica; and other inorganic fillers such as alumina, zircon, iron oxide, zinc oxide, titanium oxide, silicon nitride, boron nitride, aluminum nitride, silicon carbide, glass, silicone rubber, silicone resin, titanium oxide, carbon fiber, mica, black lead, carbon black, ferrite, graphite, diatomite, white clay, clay, talc, calcium carbonate, manganese carbonate, magnesium carbonate, barium sulfate, and silver powder, One of these fillers may be used alone, or two ore more thereof may be used in combination.

The inorganic filler may be surface-treated in order to increase the dispersibility in the resin material. Examples of the treatment agent used for the surface treatment include higher fatty acids, silane coupling agents, titanate coupling agents, sol-gel coating agents, and resin coating agents.

The water content of the inorganic filler is preferably from 0.01 to 10 wt %, more preferably from 0.01 to 5 wt %, and even more preferably from 0.01 to 1 wt % in order to reliably inhibit hydrolysis of the poly(3-hydroxyalkanoate) resins. The water content can be determined according to JIS K 5101.

The average particle size of the inorganic filler is preferably from 0.1 to 100 μm and more preferably from 0.1 to 50 μm in order to ensure good mechanical properties of the molded article and high moldability. The average particle size can be measured using a laser diffraction/scattering particle size analyzer such as “Microtrac MT3100II” manufactured by Nikkiso Co., Ltd.

Among inorganic fillers, silica is preferred since it can provide an improvement in the mechanical properties of the molded article. The silica is not limited to a particular type. In terms of usability, synthetic amorphous silica produced by a dry or wet process is preferred. Either hydrophobized or hydrophilized silica may be used. One type of silica may be used alone, or two or more types of silica may be used in combination.

The amount of the inorganic filler is not limited to a particular range and may be from 0 to 40 parts by weight per 100 parts by weight of the poly(3-hydroxyalkanoate) resin component. Although the inorganic filler need not be added, the addition of the inorganic filler offers the advantage of increasing the strength of the molded article. In the case where the inorganic filler is added, the amount of the inorganic filler is preferably from 1 to 40 parts by weight, more preferably from 5 to 35 parts by weight, and even more preferably from 10 to 30 parts by weight.

The silica is preferably used in combination with a dispersion aid in order to increase the dispersibility of the silica.

Examples of the dispersion aid include glycerin ester compounds, adipic ester compounds, polyether ester compounds, phthalic ester compounds, isosorbide ester compounds, and polycaprolactone compounds. Among these, the following compounds are preferred because they have high affinity for the resin component and are less likely to cause bleed-out: modified glycerin compounds such as glycerin diacetomonolaurate, glycerin diacetomonocaprylate, and glycerin diacetomonodecanoate; adipic ester compounds such as diethylhexyl adipate, dioctyl adipate, and diisononyl adipate; and polyether ester compounds such as polyethylene glycol dibenzoate, polyethylene glycol dicaprylate, and polyethylene glycol diisostearate. Dispersion aids containing a large amount of biomass-derived component are particularly preferred in order to increase the overall biomass degree of the resulting composition. Examples of such dispersion aids include RIKEMAL™ PL series of Riken Vitamin Co., Ltd. and Polysorb series of Roquette Frères. One dispersion aid may be used alone, or two or more dispersion aids may be used in combination.

The (total) amount of the dispersion aid(s) is not limited to a particular range, but is preferably from 0.1 to 20 parts by weight per 100 parts by weight of the total amount of the poly(3-hydroxyalkanoate) resin component. The dispersion aid(s) need not be added.

(Additives)

The blow-molded or injection-molded article according to one embodiment may contain additives to the extent that the additives do not impair the effect of the present invention. Examples of the additives include a nucleating agent, a lubricant, a plasticizer, an antistatic, a flame retardant, a conductive additive, a heat insulator, a crosslinking agent, an antioxidant, an ultraviolet absorber, a colorant, an inorganic filler, an organic filler, and a hydrolysis inhibitor, and these additives can be used depending on the intended purpose. Biodegradable additives are particularly preferred.

Examples of the nucleating agent include pentaerythritol, orotic acid, aspartame, cyanuric acid, glycine, zinc phenylphosphonate, and boron nitride. Among these, pentaerythritol is preferred because it is particularly superior in the accelerating effect on crystallization of the poly(3-hydroxyalkanoate) resin component. The amount of the nucleating agent used is not limited to a particular range, but is preferably from 0.1 to 5 parts by weight, more preferably from 0.5 to 3 parts by weight, and even more preferably from 0.7 to 1.5 parts by weight per 100 parts by weight of the total amount of the poly(3-hydroxyalkanoate) resin component. One nucleating agent may be used alone, or two or more nucleating agents may be used. The proportions of the nucleating agents used may be adjusted as appropriate depending on the intended purpose.

Examples of the lubricant include behenamide, oleamide, erucamide, stearamide, palmitamide, N-stearyl behenamide, N-stearyl erucamide, ethylenebisstearamide, ethylenebisoleamide, ethylenebiserucamide, ethylenebislauramide, ethylenebiscapramide, p-phenylenebisstearamide, and a polycondensation product of ethylenediamine, stearic acid, and sebacic acid. Among these, behenamide and erucamide are preferred because they are particularly superior in the lubricating effect on the poly(3-hydroxyalkanoate) resin component. The amount of the lubricant used is not limited to a particular range, but is preferably from 0.01 to 5 parts by weight, more preferably from 0.05 to 3 parts by weight, and even more preferably from 0.1 to 1.5 parts by weight per 100 parts by weight of the total amount of the poly(3-hydroxyalkanoate) resin component. One lubricant may be used alone, or two or more lubricants may be used. The proportions of the lubricants used can be adjusted as appropriate depending on the intended purpose.

Examples of the plasticizer include glycerin ester compounds, citric ester compounds, sebacic ester compounds, adipic ester compounds, polyether ester compounds, benzoic ester compounds, phthalic ester compounds, isosorbide ester compounds, polycaprolactone compounds, and dibasic ester compounds. Among these, glycerin ester compounds, citric ester compounds, sebacic ester compounds, and dibasic ester compounds are preferred because they are particularly superior in the plasticizing effect on the poly(3-hydroxyalkanoate) resin component. Examples of the glycerin ester compounds include glycerin diacetomonolaurate. Examples of the citric ester compounds include tributyl acetylcitrate. Examples of the sebacic ester compounds include dibutyl sebacate. Examples of the dibasic ester compounds include benzyl methyl diethylene glycol adipate. The amount of the plasticizer used is not limited to a particular range, but is preferably from 1 to 20 parts by weight, more preferably from 2 to 15 parts by weight, and even more preferably from 3 to 10 parts by weight per 100 parts by weight of the total amount of the poly(3-hydroxyalkanoate) resin component. One plasticizer may be used alone, or two or more plasticizers may be used. The proportions of the plasticizers used can be adjusted as appropriate depending on the intended purpose.

The blow-molded or injection-molded article according to one embodiment has high impact resistance. In this context, a 50% fracture energy of the molded article, as measured by a DuPont impact test, is preferably 0.3 J or more. The 50% fracture energy is more preferably 0.5 J or more and even more preferably 1 J or more. The molded article meeting the requirement concerning the 50% fracture energy can be obtained through mixing of the above-described at least two poly(3-hydroxyalkanoate) resins differing in the contents of constituent monomers. The details of how to measure the 50% fracture energy will be described in “Examples” below.

The 50% fracture energy of the blow-molded or injection-molded article according to the embodiment may be a value measured for a test specimen prepared as described in “Examples” by using resin pellets made for production of the blow-molded or injection-molded article. Alternatively, the 50% fracture energy may be a value measured for a test specimen prepared by cutting out a portion of the blow-molded or injection-molded article according to the embodiment.

The blow-molded or injection-molded article according to one embodiment preferably exhibits a flexural modulus of 500 MPa or more. The molded article that exhibits a flexural modulus of 500 MPa or more has moderate hardness and good handleability. The flexural modulus is more preferably 550 MPa or more. The molded article that exhibits such a flexural modulus can be obtained through adjustment of the proportions of the high-crystallinity and low-crystallinity poly(3-hydroxyalkanoate) resins to be mixed. The details of how to measure the flexural modulus will be described in “Examples” below.

The flexural modulus of the blow-molded or injection-molded article according to the embodiment may be a value measured for a test specimen prepared as described in “Examples” by using resin pellets made for production of the blow-molded or injection-molded article. Alternatively, the flexural modulus may be a value measured for a test specimen prepared by cutting out a portion of the blow-molded or injection-molded article according to the embodiment.

(Method for Producing Blow-Molded or Injection-Molded Article)

The blow-molded or injection-molded article according to one embodiment can be produced by making pellets as necessary and subjecting the pellets to a known blow molding or injection molding process. The details of production of the molded article will be described hereinafter.

First, the poly(3-hydroxyalkanoate) resin component is melted and kneaded, together with other components added as necessary, by using a device such as an extruder, a kneader, a Banbury mixer, or a roll mill, and thus a resin composition is prepared. The resin composition is extruded into a strand, which is then cut to obtain pellets in the form of cylindrical, elliptic cylindrical, spherical, cubic, or rectangular parallelepiped-shaped particles. Desirably, the pellets thus made are thoroughly dried at 40 to 80° C. to remove water before they are subjected to blow molding or injection molding.

The temperature for the melting and kneading depends on the properties such as melting point and melt viscosity of the resins used and cannot be definitely specified. The resin temperature of the melted kneaded product at the die outlet is preferably from 150 to 200° C., more preferably from 155 to 195° C., and even more preferably from 160 to 190° C. If the resin temperature of the melting-kneading product is lower than 150° C., the poly(3-hydroxyalkanoate) resin component could remain unmelted. If the resin temperature is higher than 200° C., the poly(3-hydroxyalkanoate) resin component could be thermally decomposed.

Next, the pellets made as above are subjected to blow molding or injection molding. Thus, a blow-molded or injection-molded article can be obtained.

The blow molding is a molding process in which air is blown into a plasticized resin material to produce a hollow molded article such as a bottle. Any of extrusion blow molding, multilayer extrusion blow molding, injection blow molding, and stretch blow molding can be used.

The injection molding is a process in which a resin composition heated and melted is injected into a mold and cooled and solidified in the mold and subsequently the mold is opened to release the molded article from the mold. The injection molding process used can be any injection molding process commonly used for molding of thermoplastic resins. Other examples include gas-assisted injection molding and injection compression molding. In-mold injection molding, gas pressure injection molding, double molding, sandwich molding, push-pull injection molding, or SCORIM can also be used. Usable injection molding processes are not limited to those mentioned above.

The use of the blow-molded or injection-molded article according to one embodiment is not limited to a particular product, and exemplary products include: bottles for beverages, liquid foods, or liquid detergents; containers; cases; toy products; recreational products; tableware; materials for agriculture; parts of OA equipment; parts of home electric appliances; structural body parts of ships or aircrafts; parts of automobiles; daily sundries; and stationery products.

### EXAMPLES

Hereinafter, the present invention will be specifically described using examples. The technical scope of the present invention is not limited by the examples given below.

The following describes the materials used in Examples and Comparative Examples.

[Poly(3-hydroxyalkanoate) Resins]

P3HB3HH-1: P3HB3HH (average content ratio 3HB/3HH=95.4/4.6 (mol %/mol %), weight-average molecular weight=66×10⁴ g/mol)

This resin was produced according to a method as described in Example 2 of WO 2019/142845.

P3HB3HH-2: P3HB3HH (average content ratio 3HB/3HH=71.8/28.2 (mol %/mol %), weight-average molecular weight=66×10⁴ g/mol)

This resin was produced according to a method as described in Example 9 of WO 2019/142845.

P3HB3HH-3: X151A (Kaneka Biodegradable Polymer PHBH™, average content ratio 3HB/3HH=89/11 (mol %/mol %), weight-average molecular weight=60×10⁴ g/mol)

P3HB3HH-4: X131A (Kaneka Biodegradable Polymer PHBH™, average content ratio 3HB/3HH=94/6 (mol %/mol %), weight-average molecular weight=60×10⁴ g/mol)

P3HB3HH-5: P3HB3HH (average content ratio 3HB/3HH=83.0/17.0 (mol %/mol %), weight-average molecular weight=59×10⁴ g/mol)

This resin was produced according to a method as described in Example 7 of WO 2019/142845.

For the case where a mixture of two or more poly(3-hydroxyalkanoate) resins was used as the poly(3-hydroxyalkanoate) resin component, the value of average HH content shown in Table 1 is an average value calculated from the HH content in each of the poly(3-hydroxyalkanoate) resins and the proportions by weight of the poly(3-hydroxyalkanoate) resins.

[Additives]

Additive-1: Pentaerythritol (Neulizer P, manufactured by Mitsubishi Chemical Corporation)

Additive-2: Behenamide (BNT-22H, manufactured by Nippon Fine Chemical Co., Ltd.)

Additive-3: Erucamide (NEUTRON-S, manufactured by Nippon Fine Chemical Co., Ltd.) The following describes methods used for evaluation in Examples and Comparative Examples.

[Evaluation of 50% Fracture Energy by DuPont Impact Test]

(Preparation of Test Specimen)

Resin pellets dried at 60° C. for 3 hours were injection-molded using an injection molding machine (CH150B, manufactured by Toyo Machinery & Metal Co., Ltd.) under the following conditions: cylinder temperature H1=160° C., H2=150° C., H3=140° C.; nozzle temperature=160° C.; mold temperature=45° C.; and cooling time=30 seconds. Thus, a molded article (80 ×mm×80 mm×1 mm) was obtained. The obtained molded article was then quartered to prepare a test specimen with a size of 40 mm×40 mm×1 mm.

(Evaluation of 50% Fracture Energy)

The test specimen was aged in a constant-temperature room at 25° C. for 7 days and then subjected to testing using a DuPont drop impact tester (manufactured by Toyo Seiki Seisaku-sho, Ltd.) according to ASTM D 2794. The test specimen thickness was 1.0 mm, the iron ball weight was from 0.3 to 2.0 kg, the impact head radius was 7.9 mm, the measurement temperature was 25° C., the number of times of measurement was 20, and the unit of energy was joule (J). The 50% fracture height was measured in the testing, and the 50% fracture energy was calculated from the measured value. The 50% fracture energy is an indicator of impact resistance; the higher the 50% fracture energy is, the higher the impact resistance is. For the case where the calculated 50% fracture energy was more than 19.8 J, the 50% fracture energy is expressed as “>19.8 J” in Table 1.

[Bottle Drop Test and Evaluation of Bottle Moldability]

(Bottle Making by Blow Molding Machine)

A single-screw extruder with a screw diameter of 40 mm was set to a cylinder temperature of 150° C. and a die temperature of 160° C. Resin pellets were introduced into and melted in the extruder, and the molten material was extruded downward from an annular die into the shape of a tube (parison). The parison was caught between two halves of a mold located below and at a distance of 20 cm from the die, and the bottom of the parison was pinched-off and sealed. Air was then blown into the parison with its one end closed, and thus the parison was shaped and cooled into a solid. As a result, an open-top bottle having an outer diameter of 60 mm and a height of 14 cm was obtained.

(Bottle Drop Test)

The bottle made as above was charged with 380 ml of water and capped. The bottle was dropped from a height of 1.5 m in such a way that the bottle was impacted at its bottom facing downward. The impact resistance was rated as “Good” when the bottle did not break into pieces and as “Poor” when the bottle broke into pieces. The impact resistance was rated as “Average” when the bottle cracked.

(Bottle Moldability)

When the parison became solidified within 30 seconds in the parison cooling-solidifying step of the bottle making, the moldability was rated as “Good”. When the solidification required 31 seconds or more, the moldability was rated as “Poor”.

[Evaluation of Flexural Modulus]

(Preparation of Test Specimen)

Resin pellets dried at 60° C. for 3 hours were injection-molded using an injection molding machine (CH150B, manufactured by Toyo Machinery & Metal Co., Ltd.) under the following conditions: cylinder temperature H1=160° C., H2=150° C., H3=140° C.; nozzle temperature=160° C.; mold temperature=45° C.; and cooling time=30 seconds. Thus, a molded article (80 mm×10 mm×4 mm) was obtained.

(Evaluation of Flexural Modulus)

The flexural modulus was evaluated using a three-point bending tester (Autograph AG-10TB, manufactured by Shimadzu Corporation) according to JIS-K 7171. As to the test conditions, the test speed was 2 mm/min, the support-to-support distance was 64 mm, and the radii of the indenter and the supports were 5.0 mm. The measurement atmosphere was set to 23° C. and 50%RH.

### Example 1

An amount of 2.25 kg of P3HB3HH-1 and 2.75 kg of P3HB3HH-2 were blended to give a resin formulation shown in Table 1. To the blend were added 50 g of Additive-1, 25 g of Additive-2, and 25 g of Additive-3, and the blend and additives were dry-blended. The resin material thus obtained (resin mixture) was introduced into and extruded by a co-rotating twin-screw extruder having a screw diameter of 26 mm, with the cylinder temperature set to 150° C. and the die temperature set to 150° C. The extruded resin material in the shape of a strand was passed through a water bath filled with 40° C. water to solidify the strand, which was then cut by a pelletizer to obtain resin composition pellets.

Test specimens for the DuPont impact test and the flexural modulus evaluation were prepared from the obtained pellets using an injection molding machine. The 50% fracture energy was measured to be 19.8 J or more, and the flexural modulus was measured to be 422 MPa.

A bottle was also made from the obtained pellets using a blow molding machine, and the bottle moldability evaluation and the bottle drop test were carried out. The bottle moldability was rated as “Good”, and the impact resistance was also rated as “Good” since the bottle did not break into pieces in the drop test. The results are summarized in Table 1.

### Examples 2 to 7 and Comparative Examples 1 to 5

Resin composition pellets were made in the same manner as in Example 1, except that the resin formulation was changed as shown in Table 1, and evaluation procedures identical to those in Example 1 were conducted. The results are summarized in Table 1.

TABLE 1

| | Resin formulation | | | | Average | 50% | | | |
|---|---|---|---|---|---|---|---|---|---|
| | First component | | Second component | | HH | fracture | | Flexural | |
| | | Amount | | Amount | content | energy | Bottle | modulus | Bottle |
| | Resin | (wt %) | Resin | (wt %) | (mol %) | (J) | drop test | (Mpa) | moldability |
| Example 1 | P3HB3HH-1 | 45 | P3HB3HH-2 | 55 | 17.6 | >19.8 | Good | 422 | Good |
| Example 2 | P3HB3HH-1 | 49 | P3HB3HH-2 | 51 | 16.6 | >19.8 | Good | 449 | Good |
| Example 3 | P3HB3HH-1 | 61 | P3HB3HH-2 | 39 | 13.8 | >19.8 | Good | 546 | Good |
| Example 4 | P3HB3HH-1 | 65 | P3HB3HH-2 | 35 | 12.9 | 9.40 | Good | 579 | Good |
| Example 5 | P3HB3HH-1 | 70 | P3HB3HH-2 | 30 | 11.7 | 2.40 | Good | 658 | Good |
| Example 6 | P3HB3HH-1 | 76 | P3HB3HH-2 | 24 | 10.3 | 0.52 | Good | 704 | Good |
| Example 7 | P3HB3HH-1 | 85 | P3HB3HH-2 | 15 | 8.1 | 0.33 | Good | 812 | Good |
| Comp. | P3HB3HH-3 | 100 | — | — | 11 | 0.26 | Average | 730 | Good |
| Example 1 | | | | | | | | | |
| Comp. | P3HB3HH-4 | 100 | — | — | 6 | 0.10 | Poor | 1427 | Good |
| Example 2 | | | | | | | | | |
| Comp. | P3HB3HH-3 | 50 | P3HB3HH-4 | 50 | 8.5 | 0.20 | Poor | 942 | Good |
| Example 3 | | | | | | | | | |
| Comp. | P3HB3HH-5 | 100 | — | — | 17 | — | — | — | Poor |
| Example 4 | | | | | | | | | |
| Comp. | P3HB3HH-1 | 91 | P3HB3HH-2 | 9 | 6.7 | 0.26 | Poor | 967 | Good |
| Example 5 | | | | | | | | | |

Table 1 reveals the following findings. In Examples 1 to 7, where 45 to 85 wt % of a high-crystallinity poly(3-hydroxyalkanoate) resin and 15 to 55 wt % of a low-crystallinity poly(3-hydroxyalkanoate) resin were used in combination, the moldability was high, and the resulting molded articles had high impact resistance as demonstrated by the fact that the molded articles exhibited a 50% fracture energy of 0.3 J or more in the DuPont impact test and achieved a good result also in the bottle drop test.

In particular, the molded articles obtained in Examples 3 to 7 exhibited a flexural modulus of 500 MPa or more and had good handleability.

In contrast, the molded articles obtained in Comparative Examples 1 to 3 and 5 had insufficient impact resistance as demonstrated by the fact that the molded articles exhibited a 50% fracture energy of less than 0.3 J in the DuPont impact test and failed to achieve a good result in the bottle drop test. In Comparative Example 4, the bottle moldability was so poor that any molded article was not able to be produced.

1. A blow-molded or injection-molded article comprising a poly(3-hydroxyalkanoate) resin component, wherein
the poly(3-hydroxyalkanoate) resin component comprises:
a copolymer (A) which is a copolymer of hydroxybutyrate units and other hydroxyalkanoate units and in which a content of the other hydroxyalkanoate units is from 1 mol % to 6 mol %; and
a copolymer (B) which is a copolymer of 3-hydroxybutyrate units and other hydroxyalkanoate units and in which a content of the other hydroxyalkanoate units is at least 24 mol %,
in the poly(3-hydroxyalkanoate) resin component, a proportion of the copolymer (A) is from 40 wt % to 90 wt % and a proportion of the copolymer (B) is from 10 wt % to 60 wt %, and
a 50% fracture energy of the molded article, as measured by a DuPont impact test, is at least 0.3 J.

2. The blow-molded or injection-molded article according to claim 1, wherein an average content of the other hydroxyalkanoate units in total monomer units constituting the poly(3-hydroxyalkanoate) resin component is from 7 mol % to 19 mol %.

3. The blow-molded or injection-molded article according to claim 1, wherein the other hydroxyalkanoate units are 3-hydroxyhexanoate units.

4. The blow-molded or injection-molded article according to claim 1 further comprising a nucleating agent, a lubricant, or a combination thereof.

5. The blow-molded or injection-molded article according to claim 1 further comprising from 1 to 30 parts by weight of an inorganic filler 100 parts by weight of the poly(3-hydroxyalkanoate) resin component.

6. The blow-molded or injection-molded article according to claim 1, wherein the proportion of the resin (A) is from 45 % to 85 wt % and the proportion of the resin (B) is from 15 wt % to 55 wt %.

7. The blow-molded or injection-molded article according to claim 1, wherein the proportion of the resin (A) is from 50 wt % to 80 wt % and the proportion of the resin (B) is from 20 wt % to 50 wt %.

8. The blow-molded or injection-molded article according to claim 1, wherein the average content of the other hydroxyalkanoate units in total monomer units constituting the poly(3-hydroxyalkanoate) resin component is from 8 mol % to 6 mol %.

9. The blow-molded or injection-molded article according to claim 1, wherein the average content of the other hydroxyalkanoate units in total monomer units constituting the poly(3-hydroxyalkanoate) resin component is from 9 mol % to 15 mol %.

10. The blow-molded or injection-molded article according to claim 1, wherein a weight-average molecular weight of the poly(3-hydroxyalkanoate) resin component is from 20×10⁴ to 200×10⁴.

11. The blow-molded or injection-molded article according to claim 1, wherein a weight-average molecular weight of the poly(3-hydroxyalkanoate) resin component is from 30×10⁴ to 100×10⁴.

12. The blow-molded or injection-molded article according to claim 1, wherein the poly(3-hydroxyalkanoate) resin component is a resin component having no crosslinked structure.

13. The blow-molded or injection-molded article according to claim 1, wherein the content of the other hydroxyalkanoate units in the copolymer (A) is from 2 mol % to 5 mol %.

14. The blow-molded or injection-molded article according to claim 1, wherein the content of the other hydroxyalkanoate units in the copolymer (B) is from 24 mol % to 99 mol %.

15. The blow-molded or injection-molded article according to claim 1, wherein the content of the other hydroxyalkanoate units in the copolymer (B) is from 24 mol % to 50 mol %.

16. The blow-molded or injection-molded article according to claim 1, further comprising at least one additional resin component different from the poly(3-hydroxyalkanoate) resin component selected from the group consisting of an aliphatic polyester resin and aliphatic-aromatic polyester resin.

17. The blow-molded or injection-molded article according to claim 16, wherein the aliphatic polyester resin is at last one selected form the group consisting of a polybutylene succinate adipate, polybutylene succinate, polycaprolactone, and polylactic acid.

18. The blow-molded or injection-molded article according to claim 16, wherein the aliphatic-aromatic polyester resin is at last one selected form the group consisting of a polybutylene adipate terephthalate, polybutylene sebacate terephthalate, and polybutylene azelate terephthalate.

19. The blow-molded or injection-molded article according to claim 16, wherein of a content of the at least one additional resin component is 30 parts by weight or less per 100 parts by weight of the total amount of the poly(3-hydroxyalkanoate) resin component.
